(19) United States
(12) Patent Application Publication
(10) Pub. No.: US 2013/0258996 A1
(43) Pub. Date: Oct. 3, 2013

(54) METHOD OF ALLOCATING RADIO RESOURCES FOR DEVICE-TO-DEVICE COMMUNICATION IN CELLULAR COMMUNICATION SYSTEM

(71) Applicants: Kwang Ryul JUNG, Daejeon (KR); Mi Jeong YANG, Daejeon (KR); Ae Soon PARK, Daejeon (KR)

(72) Inventors: Kwang Ryul JUNG, Daejeon (KR); Mi Jeong YANG, Daejeon (KR); Ae Soon PARK, Daejeon (KR)

(73) Assignee: Electronics and Telecommunications Research Institute, Daejeon (KR)

(21) Appl. No.: 13/553,166

(22) Filed: Jul. 19, 2012

(30) Foreign Application Priority Data
Mar. 28, 2012 (KR) 10-2012-0031807

(51) Int. Cl. H04W 72/04

(52) U.S. Cl. 370/330; 370/329

(57) ABSTRACT

A resource allocation method of a base station for a device-to-device (D2D) communication link based on a cellular communication system includes providing operation information which includes information about one or more resource allocation patterns available for the D2D communication link to terminals which perform D2D communication according to each terminal and each D2D communication link, receiving a buffer status report (BSR) from the terminals which perform the D2D communication, and transmitting an indication value which indicates at least one of the resource allocation patterns based on the BSR. Accordingly, in the resource allocation method, low capacity of downlink control channels is required by the base station, yet flexible and efficient allocation of resources is enabled.

### CLAIM FOR PRIORITY

This application claims priority to Korean Patent Application No. 10-2012-0031807 filed on Mar. 28, 2012 in the Korean Intellectual Property Office (KIPO), the entire contents of which are hereby incorporated by reference.

### BACKGROUND

1. Technical Field

Example embodiments of the present invention relate to device-to-device (D2D) communication, and more specifically, to a method of allocating radio resources for a D2D link in D2D communication based on a cellular communication system.

2. Related Art

Recently, as telecommunication devices equipped with a variety of new services such as smart phones, tablets, etc. are becoming rapidly popularized, the amount of data traffic in telecommunication networks has dramatically increased.

In addition, as Internet of Things (IoT) in which things are used, such as communication between people and things, or between things themselves, etc. expands beyond communication between people and people, the traffic concentrated in or transmitted from base stations is expected to increase to a level to which current base stations may not be able to handle the increased amount of traffic.

Therefore, D2D communication has been recently considered as a solution to improve performance of a conventional telecommunication network at a relatively low cost. In D2D communication technology based on a cellular communication system, data traffic is directly transmitted to each other without being relayed by a base station, but many advantages such as superior security, large cell coverage, and high-speed transmission are supported compared to conventional technologies such as WiFi Direct, Zigbee, Bluetooth, etc. because existing cellular communication technology is used as it is.

D2D communication includes centralized control of D2D communication and distributed control of D2D communication.

Centralized control of D2D communication refers to a D2D communication method in which a terminal which needs to communicate with another terminal requests a link setup from a central node (a base station in a cellular network) which performs controlling, and the central node allocates radio resources which enable D2D communication between the two terminals if the other terminal is near the terminal. Centralized control of D2D communication has advantages in which almost all operations of a terminal are controlled by a central node, radio resources allocated for a cellular link or a D2D link are reused for the D2D communication, and interferences between the D2D link and the cellular link are prevented.

On the other hand, distributed control of D2D communication refers to a method in which a link is set up through direct signal exchange between terminals by a distributed control method without depending on one central control node, and a terminal directly exchanges data with a nearby terminal using the link. FlashLinQ proposed by Qualcomm is a representative standard for distributed control of D2D communication. FlashLinQ technology corresponds to synchronous technology based on time division duplexing (TDD).

Many advantages and disadvantages alternately exist in the conventional cellular communication and the above-described D2D communication. Therefore, a communication system in which the cellular communication is combined with the above-described D2D communication is expected to ultimately become widespread.

Meanwhile, resources such as time and frequency need to be efficiently allocated to each terminal participating in D2D communication so that the D2D communication can be supported in the cellular communication. Because the resources need to be basically allocated to each of a transmission terminal and a reception terminal which are participating in D2D communication, downlink control channels are used for the resource allocation.

However, the capacity of the downlink control channels for the resource allocation is limited. In other words, the capacity of a control channel is the biggest hindrance in increasing whole system capacity through D2D communication. Therefore, improvement of the control method is needed for resources allocated to a D2D link to be efficiently informed to terminals which are participating in the D2D link.

### SUMMARY

Accordingly, example embodiments of the present invention are provided to substantially obviate one or more problems due to limitations and disadvantages of the related art.

Example embodiments of the present invention provide a resource allocation method for a device-to-device (D2D) communication link based on a cellular communication system with respect to a base station, the resource allocation method reducing the capacity of downlink control channels used by a base station, yet enabling flexible and efficient resource allocation.

Example embodiments of the present invention also provide a resource allocation method for a D2D communication link based on a cellular communication system with respect to a terminal, the resource allocation method reducing the capacity of downlink control channels requested by a base station, yet enabling flexible and efficient allocation of resources.

In some example embodiments, a resource allocation method of a base station for a D2D link includes: providing operation information which includes information about one or more resource allocation patterns available for D2D communication links to terminals which perform D2D communication according to each terminal and each D2D communication link; receiving a buffer status report (BSR) from the terminals which perform the D2D communication; and transmitting an indication value which indicates at least one of the resource allocation patterns based on the BSR.

Providing the operation information may be performed during a D2D session setup process for the terminals which perform the D2D communication.

The resource allocation method for the D2D link may further include performing cellular link communication with the terminals using resources allocated to a cellular link according to the resource allocation pattern indicated by the indication value.

The operation information may further include a counterpart terminal identifier of the D2D link and a resource allocation period for applying the one or more resource allocation patterns. In this case, the resource allocation period may be set in units of subframes or slots.

The resource allocation patterns may be patterns which specify resources which a terminal can use for transmission to or for reception from a counterpart terminal of the D2D link. In this case, the resource allocation patterns may be configured to separately specify resources which the terminal can use for transmission to the counterpart terminal of the D2D link or resources which the terminal can use for reception from the counterpart terminal of the D2D link using one of a frequency division multiplexing (FDM) scheme and a time division multiplexing (TDM) scheme or a combination of the FDM and TDM schemes. Alternatively, the resource allocation patterns may be configured to specify resources used for transmission to and for reception from the counterpart terminal of several D2D links in which the terminal participate by multiplexing the resources using one of the FDM scheme and the TDM scheme or a combination of the FDM scheme and the TDM scheme.

In other example embodiments, an operation method of a terminal which operates with resources allocated by a base station includes: receiving operation information which includes information about one or more resource allocation patterns available for a D2D communication link according to each D2D communication link; reporting a status of a data buffer to be transmitted to a counterpart terminal to the base station; receiving an indication value which indicates at least one of the resource allocation patterns from the base station based on the BSR; and performing data transmission to or data reception from the counterpart terminal of the D2D communication link based on the resource allocation pattern specified by the indication value.

The operation method of the terminal may further include performing cellular link communication with the base station using resources allocated to a cellular link according to the resource allocation pattern specified by the indication value.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram describing an environment to which a resource allocation method for a device-to-device (D2D) link in a cellular communication system according to example embodiments of the present invention is applied.

FIG. 2 and FIG. 3 are frame diagrams illustrating examples of resource allocation for describing a resource allocation method for a D2D link in a cellular communication system according to example embodiments of the present invention.

FIG. 4 is a flowchart describing a resource allocation method for a D2D link with respect to a base station according to example embodiments of the present invention.

FIG. 5 is a message sequence chart describing an associated operation between each terminal and a base station in a resource allocation method for a D2D link according to example embodiments of the present invention.

FIG. 6 is a conceptual diagram describing an example configuration of operation information used in methods according to example embodiments of the present invention.

FIG. 7 is a flowchart describing a resource allocation method for a D2D link with respect to a terminal according to example embodiments of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “terminal” used herein may refer to a mobile station (MS), a user equipment (UE), a user terminal (UT), a wireless terminal, an access terminal (AT), a subscriber unit, a subscriber station (SS), a wireless device, a wireless communication device, a wireless transmit/receive unit (WTRU), a mobile node, a mobile, or other terms. Various examples of a terminal may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an internet home appliance capable of wireless internet access and browsing, and also portable units or terminals having a combination of such functions, but a terminal is not limited thereto.

The term “base station” used herein generally denotes a fixed point communicating with a terminal, and may be referred to as a Node-B, an eNode-B, a base transceiver system (BTS), an access point, a relay, and a femto-cell, etc.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described in detail with reference to the accompanying drawings. To aid in understanding the present invention, like numbers refer to like elements throughout the description of the figures, and the description of the same component will not be reiterated.

Environment for Application of the Present Invention and Example of Resource Allocation

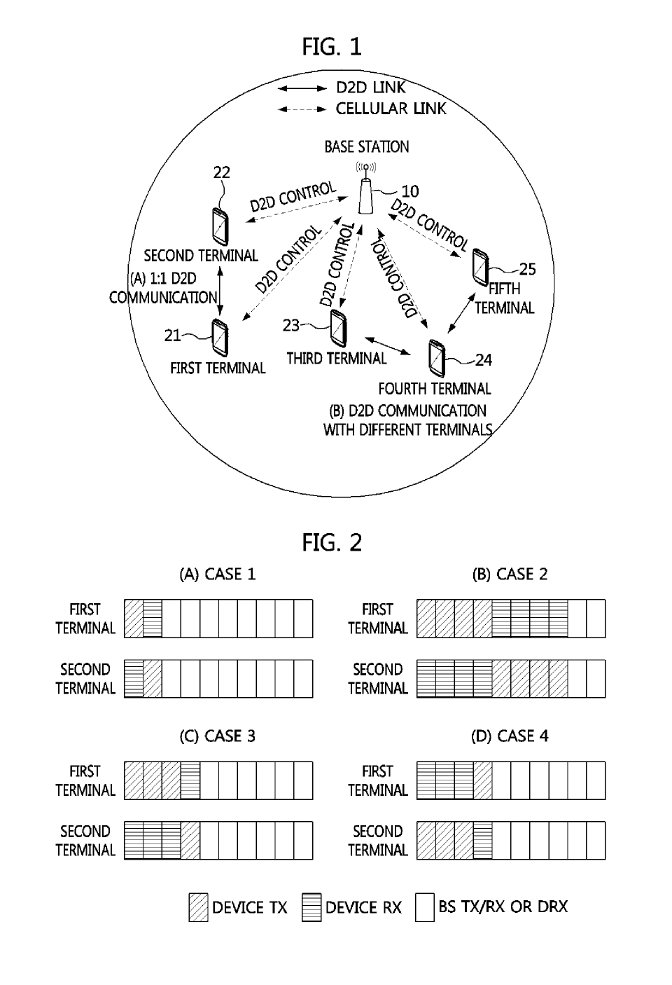

FIG. 1 is a conceptual diagram describing an environment to which a resource allocation method for a device-to-device (D2D) link in a cellular communication system according to example embodiments of the present invention is applied.

Referring to FIG. 1, a first terminal 21 performs D2D communication with a second terminal 22 under the control of a base station 10, and a fourth terminal 24 also performs D2D communication with each of a third terminal 23 and a fifth terminal 25 under the control of the base station 10.

In this case, a D2D link refers to a link for the D2D communication, and a cellular link refers to a link for communication between a terminal and a base station.

That is, the environment exemplified in FIG. 1 is an environment in which the first to fourth terminals perform D2D link communication, in other words, an environment in which the first to fourth terminals receive resource allocation information for a D2D link from the base station through a downlink control channel and perform the D2D communication based on the resource allocation information included in the downlink control channel.

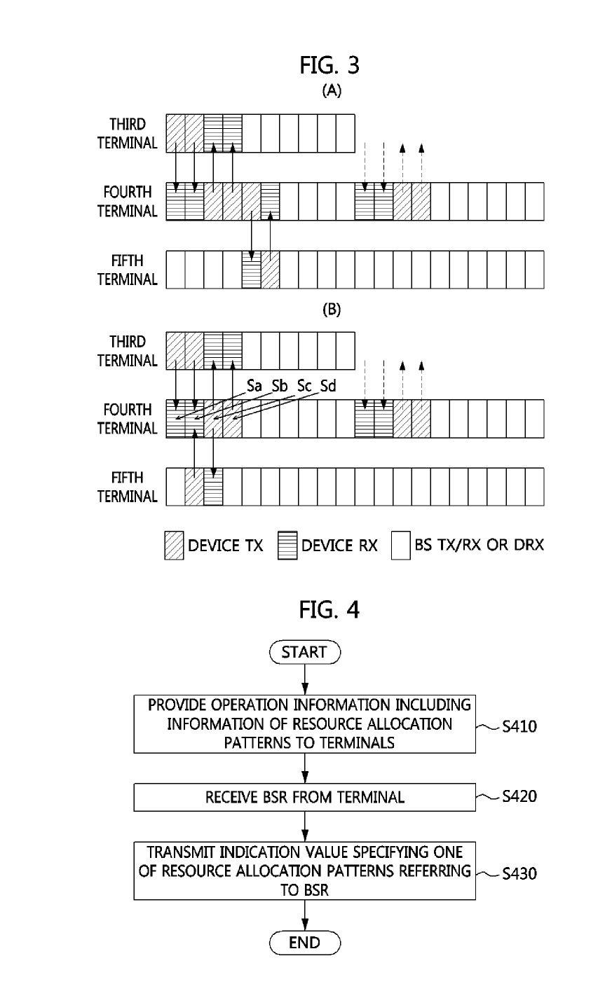

FIG. 2 and FIG. 3 are frame diagrams illustrating examples of resource allocation for describing a resource allocation method for a D2D link in a cellular communication system according to example embodiments of the present invention

FIG. 2 and FIG. 3 illustrate examples of allocating resources by separating a subframe (or a slot) for the D2D link from a subframe (or a slot) for the cellular link using a time division multiplexing (TDM) scheme. Although not shown in FIG. 2 and FIG. 3, it is possible to separately allocate resources in a subframe (or a slot) using a frequency division multiplexing (FDM) scheme or using a combination of the FDM and TDM schemes.

FIG. 2 and FIG. 3 illustrate an example of resource allocation according to a result of resource allocation determined by a base station according to a buffer status of each terminal and the base station. FIG. 2 relates to only one-to-one D2D communication and FIG. 3 relates to one-to-many D2D communication

First, referring to FIG. 2, a first case and a second case illustrate resource allocation cases in which the amounts of data transmitted from both sides of terminals of a D2D link are symmetrical, that is, the same amount of transmission resources and reception resources are allocated to both sides of the terminals. Meanwhile, third and fourth cases illustrate resource allocation cases in which the amounts of data transmitted from both sides of terminals of a D2D link are asymmetrical, that is, a greater amount of transmission resources is allocated to one of a first terminal and a second terminal.

The first case refers to a general D2D resource allocation case in which the first terminal transmits data during one subframe (or a slot) among ten subframes (or slots), receives data during one subframe (or a slot), and operates in a standby state for transmission or reception through a cellular link with the base station during eight remaining subframes.

Next, the second case refers to a resource allocation case in which the amount of data transmission between the first terminal and the second terminal is increased. In this case, the first terminal transmits data during four subframes (or slots), receives data during other four subframes (or slots), and operates in the standby state for transmission or reception through a cellular link with the base station during only two remaining subframes (or slots), among ten subframes (or slots).

On the other hand, the third and fourth cases are examples of resource allocation cases in which the amount of data transmission by the first terminal is more or less than that by the second terminal. In addition, the first, third, and fourth cases may be referred to as cases in which the amount of data of the cellular link is more than that of the D2D link.

Next, FIG. 3 shows an example of a resource allocation case in which a terminal (fourth terminal in FIG. 1(b)) performs D2D communication with each of different terminals. In this case, a scheduling assignment by the base station according to each buffer status, each transmission option, etc. is as follows.

Scheduling Assignment

terminal 3→terminal 4: transmission for 2 ms at 10 ms transmission periods

terminal 4→terminal 3: transmission for 2 ms at 10 ms transmission periods

terminal 4→terminal 5: transmission for 1 ms at 20 ms transmission periods

terminal 5→terminal 4: transmission for 1 ms at 20 ms transmission periods

In FIG. 3, since each of third and fifth terminals performs one-to-one D2D communication with a fourth terminal, the third and fifth terminals perform a similar operation as in FIG. 2. However, since the fourth terminal performs D2D communication with different terminals (the third and fifth terminals) which have different periods of resource allocation and different qualities of services (QoSs), the fourth terminal operates differently from the second terminal of FIG. 2.

FIG. 3(a) shows a case of receiving data transmitted from only one terminal or transmitting data to one terminal at a moment. In this case, a transmission option of the data to be transmitted according to particular terminals may be fixed.

FIG. 3(b) shows a case of receiving data transmitted from different terminals at the same time or transmitting data to different terminals at a moment. In this case, the fourth terminal receives data of the third terminal in a slot Sa and receives data of the third terminal and the fifth terminal in a slot Sb simultaneously. Also, the fourth terminal transmits data to the third and fifth terminals in a slot Sc at the same time and transmits data to the third terminal in a slot Sd.

Resource Allocation Method for D2D Link According to Present Invention

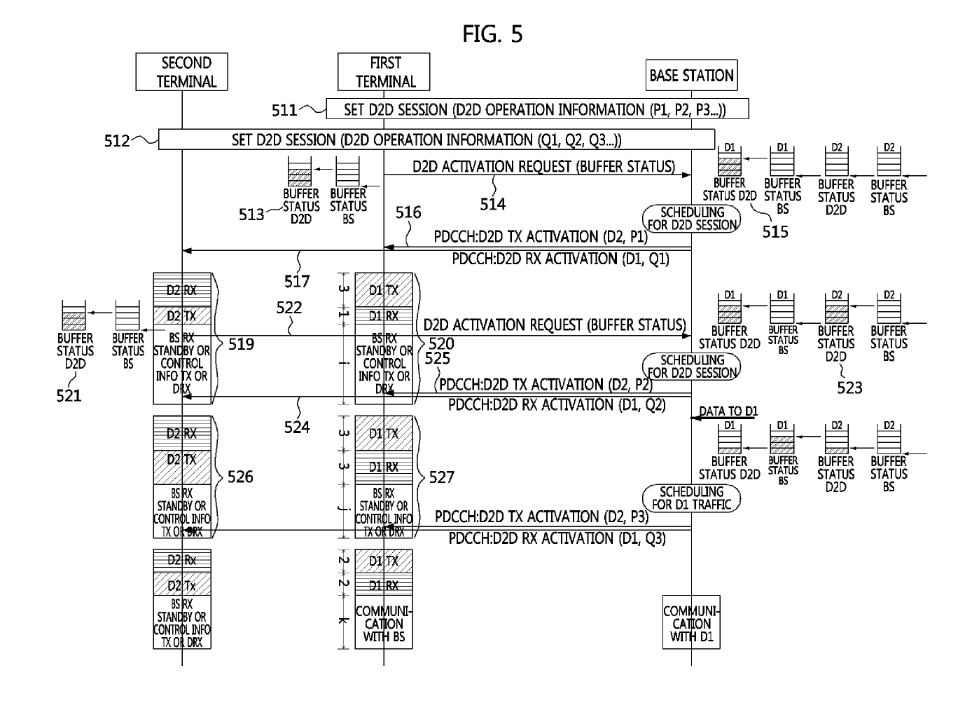

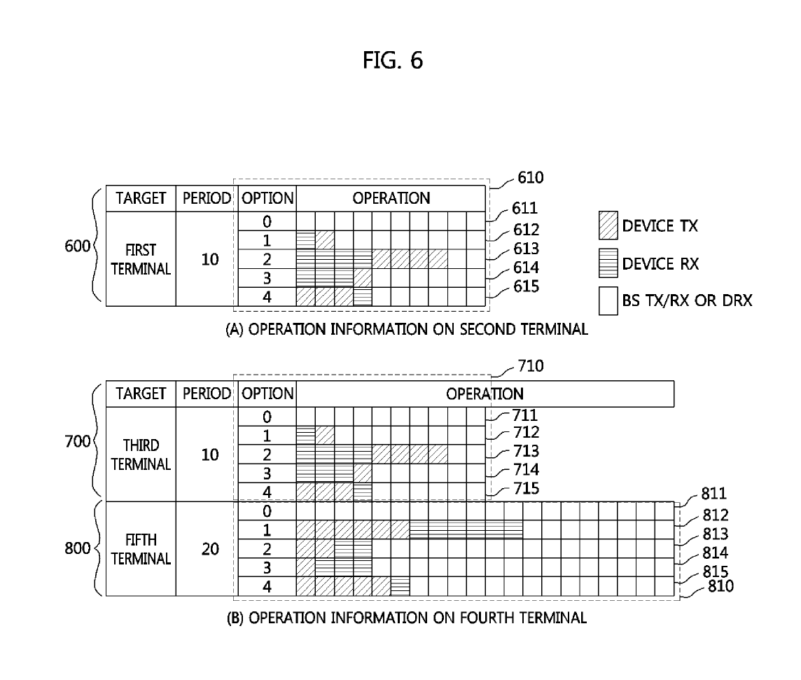

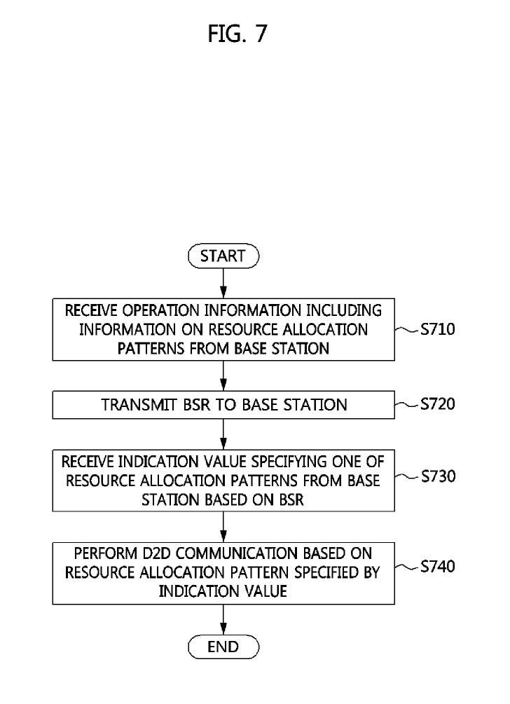

FIG. 4 and FIG. 7 are flowcharts describing resource allocation methods for a D2D link in a cellular communication system according to example embodiments of the present invention, and FIG. 5 is a message sequence chart describing an associated operation between each terminal and a base station in a resource allocation method for a D2D link according to example embodiments of the present invention, which shows D2D session setup and a D2D communication procedure according to changes in buffer status of respective terminals and the base station. In addition, FIG. 6 is a conceptual diagram describing an example configuration of “operation information” used in methods according to example embodiments of the present invention.

Methods according to example embodiments of the present invention will be described below referring to FIG. 4 and FIG. 7 along with FIG. 5 and FIG. 6 in parallel.

Referring to FIG. 4, an operation method of a base station among resource allocation methods for a D2D link in a cellular communication system according to example embodiments of the present invention may include providing operation information including information about one or more resource allocation patterns available for a D2D communication link to terminals performing D2D communication according to each terminal and each D2D communication link (S410), receiving a buffer status report (BSR) from the terminals which perform the D2D communication (S420), and transmitting an indication value which specifies at least one of the resource allocation patterns based on the BSR (S430).

Referring to FIG. 5 in parallel, in step 410, the base station transmits the operation information (to be described later) to be used for the D2D communication to the terminals which will perform the communication through the D2D link. In this case, the operation information may be provided according to each terminal or each D2D link in which the terminals participate.

First and second terminals each perform a D2D session setup process by the base station for the D2D communication with each other, and step 410 may be performed during the D2D session setup process. A device that receives the operation information in step 410 saves necessary information and waits for an operation start command from the base station.

FIG. 6 is a conceptual diagram describing example configurations of the operation information used in methods according to example embodiments of the present invention, wherein FIG. 6(a) illustrates operation information that the second terminal of FIG. 1 receives and FIG. 6(b) illustrates operation information that the fourth terminal of FIG. 1 receives.

Referring to FIG. 6, operation information may basically include information on one or more resource allocation patterns (611 to 615, 711 to 715, and 811 to 815) available for a D2D communication link. In FIG. 6, five pieces of information about five resource allocation patterns are included in one piece of operation information, but the number of included resource allocation patterns may be more or less than five.

For example, resource allocation patterns 610 which are included in operation information 600 provided to the second terminal includes a pattern 611 (option 0) in which the whole subframes (or slots) are used only for a cellular link, a pattern 612 (option 1) in which a first subframe (or a slot) and a second subframe (or a slot) are respectively allocated for transmission or reception of the D2D link and the remaining subframes (or slots) are used for the cellular link, and a pattern 613 (option 2) in which first to fourth subframes (or slots) are allocated for D2D link transmission, fifth to eighth subframes (or slots) for D2D link reception, and the remaining subframes (or slots) are used for the cellular link (description of patterns of option 3 and option 4 is omitted).

In addition, the fourth terminal participates in two D2D links at the same time, thus separately receiving operation information 700 for a case in which a counterpart is the third terminal and operation information 800 for a case in which a counterpart is the fifth terminal. In this case, resources used for transmission to and reception from the counterpart terminals of the several D2D links (two D2D links in FIG. 6) in which the fourth terminal is participating need to be multiplexed in order to avoid overlap using one of the FDM or TDM schemes or a combination of the FDM and TDM schemes.

In addition, the operation information may further include at least one of a counterpart terminal identifier (e.g., cell radio network temporary identifier (C-RNTI), temporary mobile subscriber identifier (TMSI), etc.) and a resource allocation period. When a terminal has only one 1:1 D2D link session, the counterpart terminal identifier may not necessarily be included in the operation information. In addition, when all of the D2D links have the same resource allocation period (e.g., 10 slots or 20 slots), the operation information may include only the resource allocation patterns.

Meanwhile, in FIG. 6, information on resource allocation periods and resource allocation patterns for transmission/reception are expressed in units of slots (or subframes) based on TDM as an example, but may be provided in unit of frequency based on FDM, etc.

In this case, the resource allocation periods and the resource allocation patterns are determined by the base station considering various conditions such as QoS information used for D2D session setup, wireless environment between devices, mobility, large amount of transmission, large amount of reception, large amount of communication over the cellular link, etc.

In step 420, when data for the D2D communication begins to be accumulated in a buffer of the first terminal (513), the first terminal requests the base station to perform an operation required for the D2D communication (514). Generally, because the terminal has a separate data buffer in which data to be transmitted to a counterpart terminal of each D2D link is stored, the aforementioned request for the operation may be made through a BSR of the D2D link.

In step 430, the base station that receives the request from the first terminal updates the buffer status of the first terminal (515), and performs a resultant scheduling procedure, thereby selecting an operation option appropriate for the buffer status of the first terminal (an indication value which specifies one of the resource allocation patterns included in the operation information provided to the first terminal) and commanding the first terminal to start a D2D transmission/reception procedure (516). At the same time, the base station selects an appropriate operation option and commands the second terminal which needs to receive data of the first terminal to start the D2D transmission/reception procedure (517). FIG. 5 illustrates that the base station provides the operation option to the terminals through a physical downlink control channel (PDCCH), assuming a case of 3rd Generation Partnership Project (3GPP) Long Term Evolution (LTE).

In other words, the base station transmits the terminal-specific operation options, which are obtained according to the result of performing scheduling based on the BSR of the terminal, to the respective terminals in a section in which the terminals are able to communicate with the cellular base station. In this case, the base station should select an appropriate operation option such that the operation sections do not overlap and the cellular sections in which the terminals are able to receive control information from the base station and to transmit control information to the base station are included.

The first and second terminals which receive the D2D operation options repeat D2D transmission/reception and standby for the cellular base station or the cellular link transmission/reception in a specific period according to information on resource allocation patterns (519 and 520) specified by the operation options. The repetition continues until the D2D session is terminated, and the base station appropriately controls the terminal-specific operation options by periodically receiving status of buffers for D2D communication between the first and second terminals and status of buffers for communication between each terminal and the base station (i.e., the cellular link).

For example, in FIG. 6(a), when the base station selects one of the resource allocation patterns as an operation option in every resource allocation period corresponding to 10 slots (or subframes) for D2D communication between the first terminal and the second terminal, the second terminal repeats the operation of transmission to the first terminal, reception from the first terminal, and standby for reception and communication through the cellular link according to the specified resource allocation pattern. In addition, in FIG. 6(b), the fourth terminal receives an operation option which indicates a resource allocation pattern for D2D communication with each of the third and fifth terminals, and repeats the operation every ten slots (or subframes) with the third terminal and every twenty slots (or subframes) with the fourth terminal according to the resource allocation patterns specified by the provided operation options.

In FIG. 5, portions referred to as 521 to 525 respectively illustrate a series of processes in which the second terminal transmits a BSR to the base station (522) according to changes in buffer status of the second terminal (521), and the base station updates the buffer status of the second terminal (523), and provides an operation option to each of the first and second terminals (524 and 525). A difference from the previously described cases of FIG. 2 and FIG. 3 is that, because the amount of data is increased in the data buffer of the second terminal, the operation options indicate resource allocation patterns (526 and 527) in which more resources are allocated to the transmission by the second terminal.

In step 430, the terminals need to report the buffer status of the D2D link and the cellular link in which the terminals periodically participate. In addition to the periodical BSR, the terminals may report a special buffer status (e.g., buffer empty, buffer overflow, etc.).

When a device has no D2D data or when the base station has large amount of data to be transmitted to the device, the device may only stand by for the cellular link communication or perform transmission/reception through the cellular link, as indicated by “option 0” in FIG. 6(a). In this case, transmission information used by the device (e.g., modulation/demodulation scheme, coding rate, etc.) may be information included in a command for start of a transmission/reception procedure (e.g., downlink control information (DCI) in an LTE-Advanced system) or information received for D2D session setup.

Referring to FIG. 7, an operation method of a terminal among resource allocation methods for a D2D link in a cellular communication system according to example embodiments of the present invention may include receiving operation information which includes information about one or more resource allocation patterns available for the D2D communication link according to each D2D communication link (S710), reporting status of a data buffer to be transmitted to a counterpart terminal to a base station (S720), receiving an indication value which specifies at least one of the resource allocation patterns based on the BSR from the base station (S730), and performing transmission and/or reception of data to/from the counterpart terminal of the D2D communication link based on the resource allocation pattern specified by the indication value (S740).

In step 710, the terminal receives the operation information described in the operation method of the base station. Step 710 may be performed during a D2D session setup process between the base station and the terminal.

In this case, the terminal receives the operation information according to each D2D link in which the terminal is participating. For example, the terminal may receive one set of operation information (i.e., the first, second, third, and fifth terminals in FIG. 1) when the terminal forms a D2D link with only one counterpart terminal, and the terminal may receive operation information according to each D2D link (i.e., the fourth terminal in FIG. 1) when the terminal forms D2D links with a plurality of counterpart terminals.

Because the configuration of the operation information is same as the example configuration described above with reference to FIG. 6, redundant explanation will be omitted.

In step 720, the terminal reports status of the data buffer to be transmitted to the counterpart terminal to the base station. In this case, the status of the data buffer to be transmitted is reported in the form of a BSR through the D2D link.

As mentioned above, the terminal may report the buffer status periodically and, in addition to the periodical status report, irregularly report a special buffer status (e.g., buffer empty, buffer overflow, etc.).

In step 730, the terminal receives the indication value (i.e., operation option) which specifies at least one of the resource allocation patterns from the base station, based on the BSR.

Finally, in step 740, the terminal performs data transmission/reception to/from the counterpart terminal of the D2D communication link, based on the resource allocation pattern specified by the indication value.

Using the above-described resource allocation method for a D2D link according to example embodiments of the present invention, it is possible to reduce the number of control channels required for commanding resource allocation for the D2D link and to efficiently allocate resources for the D2D link in a cellular communication system.

In particular, even when the resource allocation method for a D2D link according to example embodiments of the present invention is applied to D2D communication among several terminals or D2D communication and cellular communication need to be performed together, required capacity of a control channel can be reduced effectively.

In addition, the resource allocation method for a D2D link according to example embodiments of the present invention can provide basic advantages of D2D communication such as increase in capacity of a whole system, expansion in cell coverage, and increase in power efficiency of a device through short-range communication.

While the example embodiments of the present invention and their advantages have been described in detail, it should be understood that various changes, substitutions and alterations may be made herein without departing from the scope of the invention.

What is claimed is:

1. A resource allocation method of a base station for a device-to-device (D2D) communication link based on a cellular communication system, comprising:
providing operation information which includes information about one or more resource allocation patterns available for the D2D communication link to terminals which perform D2D communication according to each terminal and each D2D communication link;
receiving a buffer status report (BSR) from the terminals which perform the D2D communication; and
transmitting an indication value which indicates at least one of the resource allocation patterns based on the BSR.

2. The method of claim 1, wherein providing the operation information is performed during a D2D session setup process for the terminals performing the D2D communication.

3. The method of claim 1, further comprising performing cellular link communication with the terminals using resources allocated to a cellular link according to the resource allocation pattern indicated by the indication value.

4. The method of claim 1, wherein the operation information further includes a counterpart terminal identifier of the D2D link and a resource allocation period to which the one or more resource allocation patterns are applied.

5. The method of claim 4, wherein the resource allocation period is set in units of subframes or slots.

6. The method of claim 1, wherein the resource allocation patterns are patterns which specify resources which a terminal can use for transmission to or for reception from a counterpart terminal of the D2D link.

7. The method of claim 6, wherein the resource allocation patterns separately specify resources which the terminal can use for transmission to the counterpart terminal of the D2D link and resources which the terminal can use for reception from the counterpart terminal of the D2D link using one of a frequency division multiplexing (FDM) scheme and a time division multiplexing (TDM) scheme or a combination of the FDM scheme and the TDM scheme.

8. The method of claim 6, wherein the resource allocation patterns specify resources used for transmission to and reception from the counterpart terminal of several D2D links in which the terminal is participating by multiplexing the resources using one of a frequency division multiplexing (FDM) scheme and a time division multiplexing (TDM) scheme or a combination of the FDM scheme and the TDM scheme.

9. An operation method of a terminal which operates with resources allocated by a base station, for a device-to-device (D2D) communication link based on a cellular communication system, comprising:
receiving operation information which includes information about one or more resource allocation patterns available for the D2D communication link, according to each D2D communication link;
reporting a status of a data buffer to be transmitted to a counterpart terminal to the base station;
receiving an indication value which indicates at least one of the resource allocation patterns from the base station, based on the buffer status report (BSR); and
performing data transmission to or data reception from the counterpart terminal of the D2D communication link based on the resource allocation pattern specified by the indication value.

10. The method of claim 9, wherein receiving the operation information is performed during a D2D session setup process between the terminal and the base station.

11. The method of claim 9, further comprising performing cellular link communication with the base station using resources allocated to a cellular link according to the resource allocation pattern specified by the indication value.

12. The method of claim 9, wherein the operation information further includes a counterpart terminal identifier of the D2D link and a resource allocation period for applying the one or more resource allocation patterns.

13. The method of claim 12, wherein the resource allocation period is set in units of subframes or slots.

14. The method of claim 9, wherein the resource allocation patterns are patterns which specify resources which the terminal can use for transmission to or for reception from the counterpart terminal of the D2D link.

15. The method of claim 14, wherein the resource allocation patterns separately specify resources which the terminal can use for transmission to or for reception from the counterpart terminal of the D2D link using one of a frequency division multiplexing (FDM) scheme and a time division multiplexing (TDM) scheme or a combination of the FDM scheme and the TDM scheme.

16. The method of claim 14, wherein the resource allocation patterns specify resources used for transmission to or for reception from counterpart terminals of several D2D links in which the terminal is participating by multiplexing the resources using one of a frequency division multiplexing (FDM) scheme and a time division multiplexing (TDM) scheme or a combination of the FDM scheme and the TDM scheme.
